(19) United States
(12) Patent Application Publication
(10) Pub. No.: US 2026/0081378 A1
(43) Pub. Date: Mar. 19, 2026

(54) A CONNECTOR SOCKET AND CONNECTOR SYSTEM FOR MOUNTING AN EXTERNAL COMPONENT OR A PROTECTIVE CAP TO A LUMINAIRE

(71) Applicant: SIGNIFY HOLDING B.V., EINDHOVEN (NL)

(72) Inventor: ZHIPEI WANG, SHANGHAI (CN)

(21) Appl. No.: 19/108,694

(22) PCT Filed: Aug. 28, 2023
(86) PCT No.: PCT/EP2023/073468

§ 371 Date: Mar. 4, 2025

(30) Foreign Application Priority Data
Sep. 8, 2022 (WO) PCT/CN2022/117822
Nov. 3, 2022 (EP) 22205281.3

(51) Int. Cl. H01R 13/24; H01R 13/625; H01R 107/00

(52) U.S. Cl. CPC H01R 13/24; H01R 13/625; H01R 2107/00

(57) ABSTRACT

A connector socket has a cylinder-shaped head with a substantially planar end face and a substantially cylindrical side wall. The end face has slots each for receiving an electrical connector pin and the side wall comprises a set of locking channels, each for receiving a locking lug. The locking channels each comprise an entry channel having a first end which opens at the end face and a second end opposite to the first end. Two side channels extend laterally in opposite directions from the second end of the entry channel. The locking channels thereby enable rotation of an attachment (e.g. external component or protective cap) during coupling in both directions. This reduces wear of the walls that define the locking channels.

### FIELD OF THE INVENTION

This invention relates to the connection of external components to a luminaire, for example the connection of a light sensor or a wireless communications module to a luminaire.

### BACKGROUND OF THE INVENTION

It is well known to enable a luminaire to connect to an external component by providing a mechanical and electrical connector at an external surface of the luminaire housing. The external component may for example be a sensor, such as a PIR sensor to detect movement and thereby determine when lighting is required, or it may be a wireless communications module to enable wireless communication with the luminaire. The wireless communication may use coded light or it may use RF signal transmission.

The external sensing function or wireless communication function is for example an optional feature, so that a standard luminaire design may have an external connector socket which may be used to enable the additional function or functions, or it may simply be covered if the additional function or functions are not needed.

FIG. 1 shows a luminaire 10 in the form of a LED street light. The luminaire is mounted on a lamp post 12. The luminaire 10 has a connector socket 14 on an upper surface of the outer housing. A light engine is mounted within the outer housing, i.e. a LED light source and LED driver. A protective cap 16 can be attached to the connector socket 14 or an external component 18 can be attached to the connector socket, as shown in FIG. 1. There are thus two (or more) types of external device that can be connected to the socket.

One example of a standardized connector design is the so-called Zhaga system as defined in Zhaga Interface Specification Book 18. This is a twist and lock electrical and mechanical connector design using locking channels formed around the socket and lugs formed in the external device.

Zhaga is a global association of lighting companies that is standardizing interfaces of components of LED luminaires, including LED light engines, LED modules, LED arrays, holders, electronic control gears (LED drivers), sensors, communication modules and connectivity fit systems. This Book 18 defines a standardized interface between a LED Luminaire and a sensing/communication module (Luminaire Extension Module, LEX-M) that can be attached to the Luminaire. The interface is intended to be used in outdoor applications with high IP rating. The LEX-M may provide for example sensory inputs to the Luminaire or communication between the Luminaire and a network. For attaching the LEX-M to the Luminaire, the Luminaire features one or two Luminaire Extension Receptacles (LEX-R) and the LEX-M features a base plate.

The Luminaire Extension Receptacle is mounted at the exterior of the Luminaire and the contacts of this receptacle are typically connected to the Luminaire internal electronics. The Luminaire Extension Module is a separate unit which can easily be attached to the Luminaire Extension Receptacle by means of a twist-lock. Typically, it holds additional functionality to enrich the functionality of the total system. The LEX-M base plate (LEX-BP) is intended to be integrated in a LEX-M and provides all features for mating with the LEX-R. The LEX-BP can be independently Zhaga certified. The Luminaire Extension Cap (LEX-C) is a separate unit which can also easily be attached to the Luminaire Extension Receptacle by means of a twist-lock. It does not hold any functionality and is used to cover the receptacle in case no LEX-M is used.

The specification of this Book 18 defines the following elements:
The mechanical interface between the LEX-R and the LEX-BP.
The mechanical interface between the LEX-R and the LEX-C.
The keep-in area of the LEX-M.
The keep-out area of the luminaire to allow mounting of the LEX-M or LEX-C.
The electrical and communication interface between the Luminaire's LEX-R(s) and one or two LEX-Ms.

FIG. 2 shows an example of the connector socket 14 of the Zhaga system.

The socket has a cylinder-shaped head 20 with a substantially planar end face 22 and a substantially cylindrical side wall 24.

The end face has slots 25 each for receiving an electrical connector pin. The slots 26 are arcuate so that after insertion of a connector pin (or blade), rotation of the external device is still possible. The side wall 24 comprises a set of locking channels 26, each for receiving a locking lug.

The locking channels 26 each comprise an entry channel 30 having a first end 32 which opens at the end face 22 and a second end 34 opposite to the first end.

A side channel 36 extends laterally from the second end of the entry channel. The side channel has narrower section 40 leading to a wider holding section 42. The locking channel thus enables a bayonet type connection, during which the lugs are inserted in an axial direction into the entry channel and then rotated once they reach the base (the second end) of the entry channel. The arcuate slots enable this rotation while maintaining (or making) electrical contact with the connector pins of the external device.

The protective cap does not have connector pins, since there is no need for an electrical connection.

The protective cap and the alternative external devices have lugs of the same design, so they fit to the connector socket in exactly the same manner. They are in particular applied to the luminaire with the same type of rotation and removed from the luminaire with the same type of rotation. FIG. 1 shows anticlockwise rotation of the protective cover to remove it from the luminaire and it shows clockwise rotation of the external component 18 to connect it to the luminaire. The protective cover is therefore applied with clockwise rotation and the external component is removed with anticlockwise rotation.

A problem with this design is that the fitting of the external device gives rise to wear, particularly of the wall 50 that forms the narrower section of the side channel 36. If this wears, the connection of the external device to the socket is mechanically less secure, and a seal formed by the attachment of the external device may be less effective.

There is a need to reduce wear of the socket so that it can be used for more attachments and detachments of external devices.

US 20170373420A1 discloses an electrical connector for Christmas lamp trees.

DE 202021103399U1 discloses a connection socket of a lamp.

DE 202021104462U1 discloses a connection socket of a light, in particular a street and path light.

### SUMMARY OF THE INVENTION

The invention is defined by the claims.

According to examples in accordance with an aspect of the invention, there is provided a connector socket for mounting to a luminaire housing, to enable electrical and mechanical connection of an external component to the luminaire and, in the alternative, to enable mechanical connection of a protective cap for the connector socket, wherein the connector socket comprises a cylinder-shaped head having a substantially planar end face and a substantially cylindrical side wall, wherein:
the end face comprises a set of slots each for receiving an electrical connector pin; and
the side wall comprises a set of locking channels, each for receiving a locking lug, wherein the locking channels each comprise:
an entry channel having a first end which opens at the end face and a second end opposite to the first end; and
two side channels extending laterally in opposite directions from the second end of the entry channel, each side channel having a narrower section leading to a wider holding section;
wherein the connector socket is compatible with a Luminaire Extension Module (LEX-M), a Luminaire Extension Module Base Plate (LEX-BP) and a Luminaire Extension Cap (LEX-C) according to Zhaga Interface Specification Book 18.

This connector socket has locking channels which enable rotation of an attachment (e.g. external component or protective cap) during coupling, to move a lug into the holding sections, in one of two possible directions. The locking channels are recessed radially inwardly of the cylindrical side wall. This design enables one direction to be used for one type of component (e.g. an external electrical component) and the other direction to be used for another type of component (e.g. a protective cap). The walls which define the narrower section of the side channels in particular are prone to wear and tear in use as mentioned above. By providing two narrower sections leading to two holding sections, wear and tear is shared giving the connector a longer lifetime, in terms of the number of times a protective cap can be removed and an external component can be connected (or an external component can be removed and a protective cap can be connected).

The set of slots for example comprises four slots and the set of channels for example comprises three channels.

The invention also provides a connector system, comprising:
the connector socket as defined above; and
a protective cap for fitting to the connector socket, wherein the protective cap comprises:
   a cover which defines a void for receiving the head of the connector socket; and
   a set of locking lugs to be received in the locking channels, wherein each locking lug comprises a head to be rotated past one of the narrower sections into the associated holding section of the locking channel.

This defines the combination of the connector socket and a protective cap to be attached to the socket. The protective cap is designed to be rotated in one direction to provide the locking of the heads of the locking lugs into the holding sections, and it thus engages past only one of the narrower sections. The locking lugs for example extend radially inwardly from the outer surface that defines the void.

The invention also provides a connector system, comprising:
the connector socket as defined above; and
a component connector for fitting an external component to the connector socket, wherein the component connector comprises:
   a cover which defines a void for receiving the head of the connector socket;
   a set of electrical connector pins to be received in the set of slots of the connector socket; and
   a set of locking lugs to be received in the locking channels, wherein each locking lug comprises a head to be rotated past one of the narrower sections into the associated holding section of the locking channel.

This defines the combination of the connector socket and a connector for an external component to be attached to the socket. The component connector is designed to be rotated in one direction to provide the locking of the locking lugs into the holding sections, and it thus engages past only one of the narrower sections. The component connector is for example part of the external component, such as a sensor or wireless communications device.

The invention also provides a connector system, comprising:
the connector socket as defined above;
a protective cap for fitting to the connector socket, wherein the protective cap comprises:
   a first cover which defines a void for receiving the head of the connector socket; and
   a first set of locking lugs to be received in the locking channels, wherein each locking lug of the first set comprises a head to be rotated past one of the narrower sections into the associated holding section of the locking channel; and
a component connector for fitting an external component to the connector socket, wherein the component connector comprises:
   a second cover which defines a void for receiving the head of the connector socket;
   a set of electrical connector pins to be received in the set of slots of the connector socket; and
   a second set of locking lugs to be received in the locking channels, wherein each locking lug of the second set comprises a head to be rotated past one of the narrower sections into the associated holding section of the locking channel,
wherein the heads of the locking lugs of the protective cap are for rotation in one direction to fit into first holding sections of the locking channels and the heads of the locking lugs of the component connector are for rotation in an opposite direction for fitting into different second holding sections of the locking channels.

This defines the combination of the connector socket, the protective cap to be attached to the socket and a connector for an external component to be attached to the socket. Thus, in a system with a socket for a luminaire and connectors for a protective cap and for an external component, the protective cap and the external component are fitted using rotation in different (opposite) directions, so that different narrower sections are subjected to wear and tear.

The invention also provides a luminaire comprising:
a luminaire housing;
a light engine inside the luminaire housing; and
a connector socket as defined above fitted to the luminaire housing.

The connector socket is for example integrated into the luminaire housing and thus defines an external interface for an external component or protective cap.

The invention also provides a luminaire system comprising:
the luminaire defined above; and
a protective cap for fitting to the connector socket, wherein the protective cap comprises:
   a cover which defines a void for receiving the head of the connector socket; and
   a set of locking lugs to be received in the locking channels, wherein each locking lug comprises a head to be rotated past one of the narrower sections into the associated holding section of the locking channel of the connector socket.

This defines a luminaire with associated protective cap.

The invention also provides a luminaire system comprising:
the luminaire defined above; and
an external component for connection to the luminaire housing, wherein the external component comprises a component connector for fitting the external component to the connector socket, wherein the component connector comprises:
   a cover which defines a void for receiving the head of the connector socket;
   a set of electrical connector pins to be received in the set of slots of the connector socket; and
   a set of locking lugs to be received in the locking channels, wherein each locking lug comprises a head to be rotated past one of the narrower sections into the associated holding section of the locking channel of the connector socket.

This defines a luminaire with associated external component.

The external component for example comprises a sensor or a wireless communications device.

The invention also provides a luminaire system comprising:
the luminaire defined above;
a protective cap for fitting to the connector socket; and
an external component for connection to the luminaire housing,
wherein the protective cap comprises:
   a first cover which defines a void for receiving the head of the connector socket; and
   a first set of locking lugs to be received in the locking channels, wherein each locking lug of the first set comprises a head to be rotated past one of the narrower sections into the associated holding section of the locking channel of the connector socket,
wherein the external component comprises a component connector for fitting the external component to the connector socket, wherein the component connector comprises:
   a second cover which defines a void for receiving the head of the connector socket;
   a set of electrical connector pins to be received in the set of slots of the connector socket; and
   a second set of locking lugs to be received in the locking channels, wherein each locking lug comprises a head to be rotated past one of the narrower sections into the associated holding section of the locking channel of the connector socket,
and wherein the heads of the locking lugs of the protective cap are for rotation in one direction to fit into first holding sections of the locking channels and the heads of the locking lugs of the component connector are for rotation in an opposite direction for fitting into different second holding sections of the locking channels.

This defines a luminaire with associated protective cap and external component. Again, the external component may comprise a sensor or a wireless communications device.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a luminaire in the form of a LED street light ;

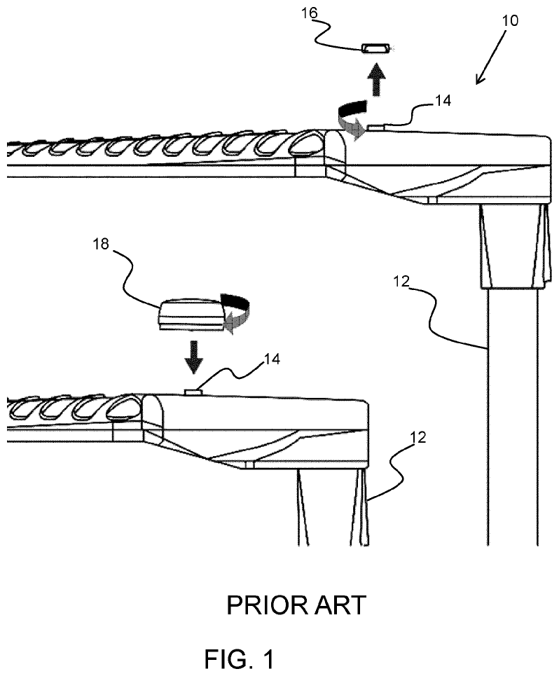

FIG. 2 shows an example of a known connector socket of the Zhaga system;

FIG. 3 shows a connector socket in accordance with the invention;

FIG. 4 shows a protective cap to be mounted to the connector socket;

FIG. 5 shows the underside of the protective cap;

FIG. 6 shows the protective cap after mounting to the connector socket;

FIG. 7 shows an electrical component to be mounted to the connector socket;

FIG. 8 shows the underside of the electrical component; and

FIG. 9 shows the electrical component after mounting to the connector socket.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a connector socket which has a cylinder-shaped head with a substantially planar end face and a substantially cylindrical side wall. The end face has slots each for receiving an electrical connector pin and the side wall comprises a set of locking channels, each for receiving a locking lug. The locking channels each comprise an entry channel having a first end which opens at the end face and a second end opposite to the first end. Two side channels extends laterally in opposite directions from the second end of the entry channel. The locking channels thereby enable rotation of an attachment (e.g. external component or protective cap) during coupling in both directions. This reduces wear of the walls that define the locking channels.

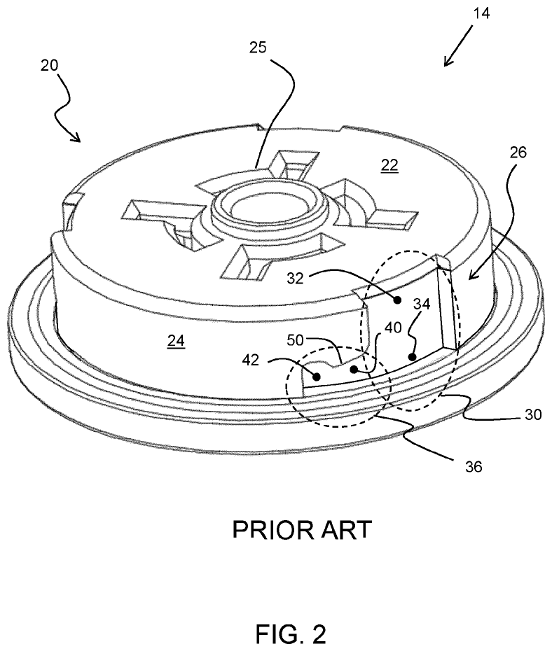

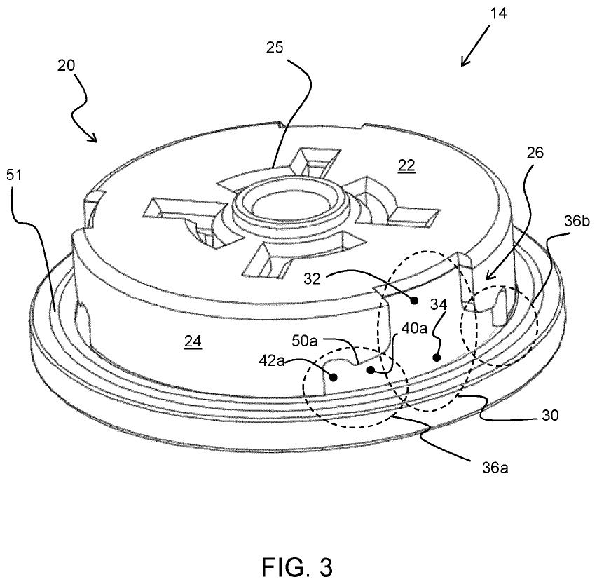

FIG. 3 shows a connector socket 14 in accordance with the invention. It is shown as a modification to the design of FIG. 2, and the same components are given the same reference numerals as in FIG. 2.

The connector socket 14 is for mounting to a luminaire housing, to enable electrical and mechanical connection of an external component to the luminaire and, in the alternative, to enable mechanical connection of a protective cap for the connector socket.

As for the design of FIG. 2, the connector socket 14 comprises a cylinder-shaped head 20 having a substantially planar end face 22 and a substantially cylindrical side wall 24, and the end face comprises a set of slots 25 each for receiving an electrical connector pin.

The side wall 24 again comprises a set of locking channels 26, each for receiving a locking lug, and each locking channel comprises an entry channel 30 having a first end 32 which opens at the end face 22 and a second end 34 opposite to the first end.

In the design of the invention, there are two side channels 36a, 36b extending laterally in opposite directions from the second end 34 of the entry channel 30. Thus, they extend in opposite rotational directions around the head 20. Each side channel has a narrower section (only one, 40a, is labeled) leading to a wider holding section (only one, 42a, is labeled). The locking channels are recessed radially inwardly of the cylinder-shaped head, and the channel shape is defined by a channel side wall, including a portion which defines the narrower section (one such portion 50a is labeled in FIG. 3).

The locking channels are for receiving and holding a lug of a connector of an attachment. The attachment may be an external electrical component or a protective cap as explained above. The attachment is a push-and-twist bayonet type coupling. The connection of the attachment for example applies a force to compress a seal 51.

By having two side channels, a suitably designed lug can be provided for movement in one or other of the two possible rotation directions. In this way, one direction can be used for one type of component (e.g. external electrical component) and the other direction can be used for another type of component (e.g. protective cap). The walls which define the narrower section, such as 50a, are prone to wear and tear in use so that by providing two narrower sections leading to two holding sections, wear and tear is shared, thereby giving the connector socket a longer lifetime, in terms of the number of times a protective cap can be removed and an external component can be connected, or an external component can be removed and a protective cap can be connected.

The example shown has four slots 25 and three channels 26. However, the same concept may be applied to a different number of channels and a different electrical connector design.

In preferred examples, the connector socket is compatible with existing Zhaga external components and existing Zhaga protective caps. These existing components may be used even if they are designed for connection with the same rotational direction.

By instead providing a different design of the protective cap, the socket can be used with existing external components and with the new design of protective cap, such that they are applied in opposite rotational directions, hence using different side channels. In this way, wear and tear is shared.

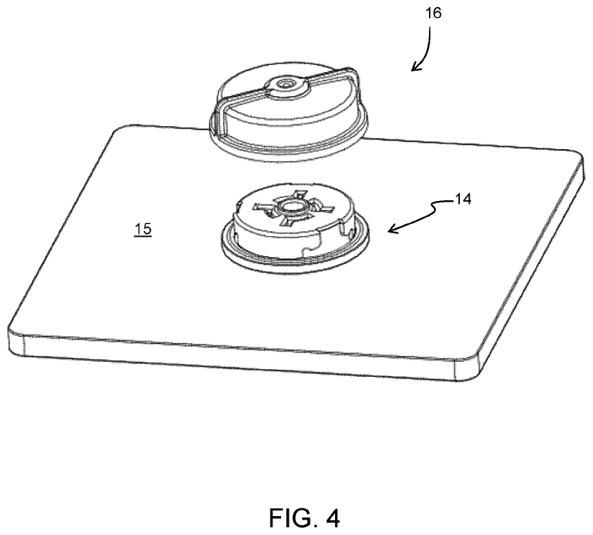

FIG. 4 shows a protective cap 16 to be mounted to the connector socket 14. The connector socket is sealingly integrated into a luminaire housing 15.

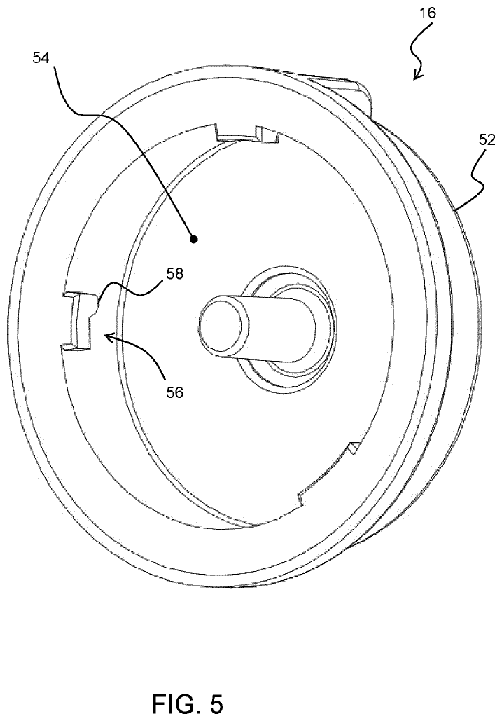

FIG. 5 shows the underside of the protective cap 16. The protective cap 16 comprises a (first) cover 52 which defines a (first) void 54 for receiving the head of the connector socket.

A (first) set of locking lugs 56 project radially towards the void 54 to be received in the locking channels. Each locking lug 56 of his (first) set comprises a head 58 to be rotated past one of the narrower sections into the associated holding section of the locking channel.

In this example, when looking down from above the protective cap 16, the head 58 is at the anticlockwise end of the lug 56. The lug is therefore designed to be rotated anticlockwise into the side channel, i.e., into the side channel 36b shown in FIG. 3. Once rotated, the head 58 is retained in the holding section of the side channel 36b after having passed the narrower section. The head is seated at the closed end of the side channel 36b.

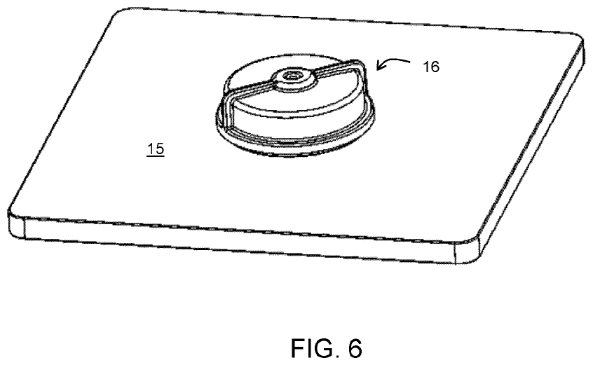

FIG. 6 shows the protective cap 16 after mounting to the connector socket. The protective cap provides a seal over the socket.

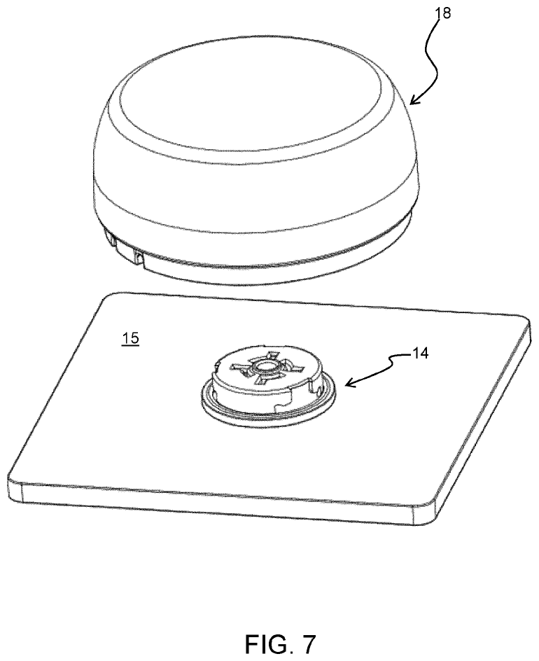

FIG. 7 shows an electrical component 18 to be mounted to the connector socket 14.

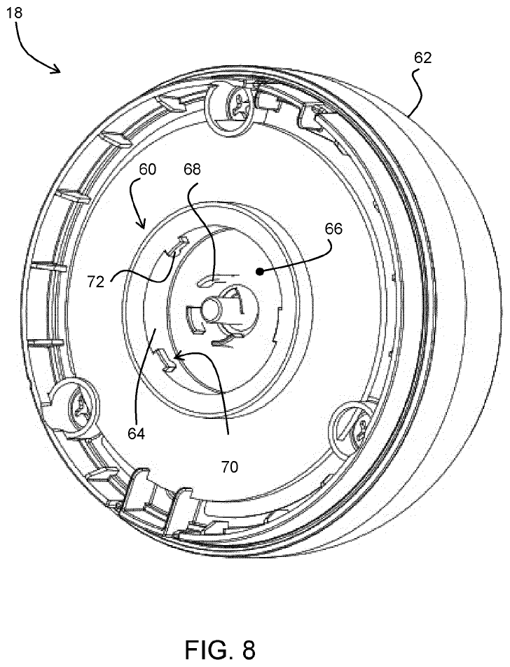

FIG. 8 shows the underside of the electrical component 18. It comprises a central component connector 60 which is retained by a main housing 62 of the electrical component. The component connector 60 comprises a (second) cover 64 which defines a (second) void 66 for receiving the head of the connector socket. A set of electrical connector pins 68 projects into the void 66 to be received in the set of slots of the connector socket. The protective cap does not need any such electrical connector pins.

A (second) set of locking lugs 70 project radially towards the void 66 to be received in the locking channels. Each locking lug 70 of this (second) set comprises a head 72 to be rotated past one of the narrower sections into the associated holding section of the locking channel.

In this example, when looking down from above the component 18, the head 72 is at the clockwise end of the lug 70. The lug is therefore designed to be rotated clockwise into the side channel, i.e., into the side channel 36a shown in FIG. 3. Once rotated, the head 72 is retained in the holding section 42a after having passed the narrower section 40a.

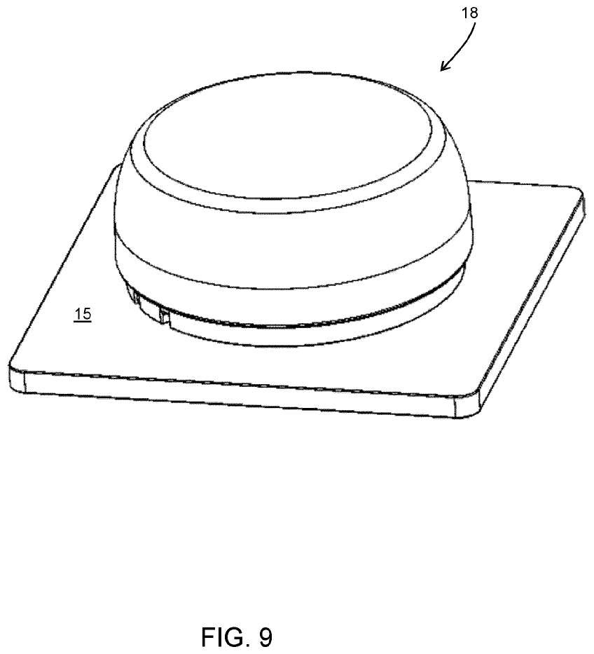

FIG. 9 shows the electrical component 18 after mounting to the connector socket. The mounting of the electrical component is sealed over the housing.

A first possible connector system for example comprises the connector socket 14 and the protective cap 18 for fitting to the connector socket. A second possible connector system for example comprises the connector socket 14 and the component connector 60 for fitting the external component to the connector socket. A complete connector system for example comprises the connector socket 14, the protective cap 18 for fitting to the connector socket and the component connector 60 for fitting the external component to the connector socket. The heads of the locking lugs of the protective cap are then for rotation in one direction to fit into first holding sections of the locking channels and the heads of the locking lugs of the component connector are for rotation in an opposite direction for fitting into different second holding sections of the locking channels. For this purpose, the heads are at opposite ends of the lugs, i.e. the first lugs have the heads at a clockwise end and the second lugs have the heads at an anticlockwise end.

The invention is for example of interest for outdoor luminaires, such as streetlights. There is for example an increasing interest to use the streetlight infrastructure to create a wireless communications mesh, by providing the luminaires with wireless communication capability.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a”or “an”does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A connector socket for mounting to a luminaire housing, to enable electrical and mechanical connection of an external component to the luminaire and, in the alternative, to enable mechanical connection of a protective cap for the connector socket, wherein the connector socket comprises a cylinder-shaped head having a substantially planar end face and a substantially cylindrical side wall, wherein:
the end face comprises a set of slots each for receiving an electrical connector pin; and
the side wall comprises a set of locking channels, each for receiving a locking lug, wherein the locking channels each comprise:
an entry channel having a first end which opens at the end face and a second end opposite to the first end; and
two side channels, extending laterally in opposite directions from the second end of the entry channel, each side channel having a narrower section leading to a wider holding section;
wherein the connector socket is compatible with a Luminaire Extension Module (LEX-M), a Luminaire Extension Module Base Plate (LEX-BP) and a Luminaire Extension Cap (LEX-C) according to Zhaga Interface Specification Book 18.

2. The connector socket of claim 1, wherein the set of slots comprises four slots.

3. The connector socket of claim 1, wherein the set of channels comprises three channels.

4. A connector system, comprising:
the connector socket of claim 1; and
a protective cap for fitting to the connector socket, wherein the protective cap comprises:
a cover which defines a void for receiving the head of the connector socket; and
a set of locking lugs to be received in the locking channels, wherein each locking lug comprises a head to be rotated past one of the narrower sections into the associated holding section of the locking channel.

5. A connector system, comprising:
the connector socket of claim 1; and
a component connector for fitting an external component to the connector socket, wherein the component connector comprises:
a cover which defines a void for receiving the head of the connector socket;
a set of electrical connector pins to be received in the set of slots of the connector socket; and
a set of locking lugs to be received in the locking channels, wherein each locking lug comprises a head to be rotated past one of the narrower sections into the associated holding section of the locking channel.

6. A connector system, comprising:
the connector socket of claim 1;
a protective cap for fitting to the connector socket, wherein the protective cap comprises:
a first cover which defines a void for receiving the head of the connector socket; and
a first set of locking lugs to be received in the locking channels, wherein each locking lug of the first set comprises a head to be rotated past one of the narrower sections into the associated holding section of the locking channel; and
a component connector for fitting an external component to the connector socket, wherein the component connector comprises:
a second cover which defines a void for receiving the head of the connector socket;
a set of electrical connector pins to be received in the set of slots of the connector socket; and
a second set of locking lugs to be received in the locking channels, wherein each locking lug of the second set comprises a head to be rotated past one of the narrower sections into the associated holding section of the locking channel,
wherein the heads of the locking lugs of the protective cap are for rotation in one direction to fit into first holding sections of the locking channels and the heads of the locking lugs of the component connector are for rotation in an opposite direction for fitting into different second holding sections of the locking channels.

7. A luminaire comprising:
a luminaire housing;
a light engine inside the luminaire housing; and
a connector socket of claim 1 fitted to the luminaire housing.

8. A luminaire system comprising:
the luminaire of claim 7; and
a protective cap for fitting to the connector socket, wherein the protective cap comprises:
a cover which defines a void for receiving the head of the connector socket; and
a set of locking lugs to be received in the locking channels, wherein each locking lug comprises a head to be rotated past one of the narrower sections into the associated holding section of the locking channel of the connector socket.

9. A luminaire system comprising:
the luminaire of claim 7; and
an external component for connection to the luminaire housing, wherein the external component comprises a component connector for fitting the external component to the connector socket, wherein the component connector comprises:
a cover which defines a void for receiving the head of the connector socket;
a set of electrical connector pins to be received in the set of slots of the connector socket; and
a set of locking lugs to be received in the locking channels, wherein each locking lug comprises a head to be rotated past one of the narrower sections into the associated holding section of the locking channel of the connector socket.

10. The luminaire system of claim 9, wherein the external component comprises a sensor or a wireless communications device.

11. A luminaire system comprising:
the luminaire of claim 7; and
a protective cap for fitting to the connector socket;
an external component for connection to the luminaire housing,
wherein the protective cap comprises:
a first cover which defines a void for receiving the head of the connector socket; and
a first set of locking lugs to be received in the locking channels, wherein each locking lug of the first set comprises a head to be rotated past one of the narrower sections into the associated holding section of the locking channel of the connector socket,
wherein the external component comprises a component connector for fitting the external component to the connector socket, wherein the component connector comprises:
a second cover which defines a void for receiving the head of the connector socket;
a set of electrical connector pins to be received in the set of slots of the connector socket; and
a second set of locking lugs to be received in the locking channels, wherein each locking lug comprises a head to be rotated past one of the narrower sections into the associated holding section of the locking channel of the connector socket,
and wherein the heads of the locking lugs of the protective cap are for rotation in one direction to fit into first holding sections of the locking channels and the heads of the locking lugs of the component connector are for rotation in an opposite direction for fitting into different second holding sections of the locking channels.

12. The luminaire system of claim 11, wherein the external component comprises a sensor or a wireless communications device.
